(19) United States
(12) Patent Application Publication
(10) Pub. No.: US 2008/0066690 A1
(43) Pub. Date: Mar. 20, 2008

(54) Combination animal grooming and de-shedding tool

(76) Inventor: Leon D. Rosen, Laguna Beach, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/903,053

(22) Filed: Sep. 20, 2007

Related U.S. Application Data
(60) Provisional application No. 60/845,848, filed on Sep. 20, 2006.

(51) Int. Cl. A01K 13/00

(52) U.S. Cl. 119/612; 119/601

(57) ABSTRACT

The present invention is directed to a combination animal grooming tool consisting of a device with a handle connected to a head with a rotating unit having two or more grooming fixtures. The first fixture is a rake-brush section consisting of a plurality of prongs and the second fixture is a de-shedding unit that is solid stainless steel tapered with a plurality of teeth spaced 0.025 inches apart. The stainless steel de-shedding unit is set into a boss on the rotating unit. An ergonomic tool handle has an orifice in the distal end for hanging in a storage location. A plurality or ribs extend the length of the handle giving a comfortable non-slip surface. The handle connects to the tool head section by the means of the tool neck. The tool head section is composed of a first side member and a second side member with a supporting central web between them. The rake-brush section of the rotating unit has a plurality of prongs in one or more lines across the rotating unit. A thumb tab is located between the rake brush section and the de-shedding unit to press on, moving the rotating unit back and forth for the desired grooming operation. The rotating unit incorporates a unique locking mechanism that restrains the unit in either the rake-brush position or the de-shedding position.

This patent application claims the benefit of US provisional patent application Ser. No. 60/845,848 filed on Sep. 20, 2006.

### FIELD OF THE INVENTION

This invention relates to a combination tool specifically designed for the purpose of brushing and removing the undercoat of a variety of animals. During the spring and summer months animals have the tendency of shedding their winter undercoat. Animals such dogs and cats which are kept indoors during this time will drop a great deal of loose hair within the house of the pet owner and also have the tendency to become overheated due to the accumulation of matted hair within their coat. This is why occasional grooming is essential to keep a pet happy and healthy.

### BACKGROUND OF THE INVENTION

A wide variety of animal grooming tools are on the market, primarily sold in the pet stores to be used for grooming of dogs and cats, but it must be understood a great many of other domestic animals have the problem of shedding the winter undercoat in the spring and summer months requiring grooming. This device is not limited to just the care and grooming of dogs and cats but can be used on a wide variety of domestic animals and thus will be covered within the scope of this patent. It is also foreseen that the device will also be used in zoos, humane societies and other animal care facilities for the care of domestic as well as undomesticated animals.

Bristle brushes are the most common grooming brushes with others made from plastic and still others with fine wire. The fine wire brushes are most commonly used to remove the undercoat of the animals although problems arise with the fine wire brushes often being abrasive to the skin of the animal. There is also a variety of combs, both plastic and metal on the market. Animals usually require being restrained during the grooming process requiring one hand for holding and comforting the animal, with the other for holding the grooming tool. Two separate tools can become difficult when you have only one hand to perform the operation. Using a brush or a comb is normally an operation where the individual holds the comb or brush and moves it sideways through the animals coat. In care facilities where workers are required to groom many animals, or for elderly people, the sideways pressure on the wrist can after a period of time cause problems such as carpel tunnel syndrome. The inventers have devised a unique single, combination grooming tool that can be easily changed from a rake-brush to a de-shredding tool by just pushing the thumb extension and be pulled through the coat of the animal in the direction of the wrist, removing the undo stress of the sideways movements.

U.S. Pat. No. 4,237,822 of LeRoy E. Kaiser describes a brush with a hollow body containing a liquid medication. Detachably mounted on the bottom of the body is a hollow head communicating with a plurality of depending elongated hollow teeth. Enclosed within the hollow body is a pump manually operated by a lever on the side of the brush handle for forcing the liquid medication into the hollow head and out the hollow teeth in a controlled manner.

This patent describes a brush for dispensing medication and does not incorporate the rake brush or de-shedding components described within this disclosure.

U.S. Pat. No. 4,685,423 of Rodney C, Baker et al. provides an article for grooming an animal and comprising a grooming article of plastics material, the plastics material containing, over at least a portion thereof, one insecticide capable of blooming from the article onto the animal when the article is used. The article may be a brush or comb. If desired, only a portion thereof may contain insecticide.

This is another patent that describes a brush for dispensing medication and does not incorporate the rake brush or de-shedding components described within this disclosure.

U.S. Pat. No. 6,336,428 of Laura H. Locke describes a vacuum pet brush for collecting debris loosened by a grooming brush or comb. The vacuum pet brush includes a main housing that has an open end and closed end. The closed end of the main housing has a plurality of venting apertures. The main housing has enclosed inside a vacuum bag, a fan connected to a motor, and a battery operationally connected to the motor. In addition, a grooming head member that has a debris collection conduit is selectively coupled to the open end of the main housing.

This patent describes a brush with a vacuum attachment for collecting the hair while grooming a pet. It does not have the capability of rotating between a rake brush and a de-shedding operation, and would require the sideways operation that puts a strain on the wrist of the individual using the brush.

U.S. Pat. No. 7,077,076 of Angela L. Porter et al. describes a pet grooming tool, for use with a furry pet such as a dog or cat having loose hair and non-loose hair, that is adapted for removing the loose hair from the pet. The grooming tool comprises an elongate handle portion extending generally along a handle axis, and a pet engageable portion secured to the handle portion. The pet engageable portion includes a blade portion and a plurality of teeth. The blade portion includes a blade edge. The teeth are extending from the blade edge. The pet engageable portion is secured to the handle portion in a manner so that pulling the handle portion generally along the handle axis while the pet engageable portion is in engagement with the pet causes the blade portion to engage the loose hair of the pet and pull it from the pet without cutting or pulling the non-loose hair from the pet.

This patent describes a grooming tool with a single grooming tool for removing loose hair from an animal such as a dog or cat. Although you pull the tool through the hair of the animal, there is only one process this tool can perform.

None of the foregoing prior art teaches or suggests the particular unique features of the combination animal grooming tool and thus clarifies the need for further improvements in the devices for animal care.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The principal advantage of the combination animal grooming tool is to supply a single tool that will perform two separate tasks of grooming animals.

Another advantage of the device is to supply a unique de-shedding element on a rotating head.

Still another advantage of the device is to supply a unique rake-brush on the same rotating head.

Another advantage of the device is to have a rotating head that will rotate between the de-shedding element and the rake-brush by pushing the thumb tab.

Another advantage of the device is to have the rotating head, lock from one position to the other when pushed by the thumb tab.

Another advantage of the combination animal grooming tool is to be able to pull it through the coat of the animal rather than draw it sideways as you would with a comb, which causes a strain on the wrist of the individual using the device.

A further advantage is to create a combination animal grooming tool with a comfortable ergonomically designed non-slip handle.

And yet another advantage of this invention is to add a new and unique device to the area of animal grooming.

These together with other objects of the combination animal grooming tool, along with the various features of novelty, which characterize the device, are pointed out with particularity in the claims annexed to and forming a part of this disclosure. For a better understanding of the combination animal grooming tool, its operating advantages and the specific objects attained by its uses, reference should be made to the accompanying drawings and descriptive matter in which there are illustrated preferred embodiments of the invention. There has thus been outlined, rather broadly, the more important features of the device in order that the detailed description thereof that follows may be better understood, and in order that the present contribution to the art may be better appreciated. There are additional features of the device that will be described hereinafter and which will form the subject matter of the claims appended hereto.

The preferred embodiment of the combination animal grooming tool will consist of a device with a handle connected to a head with a rotating unit having two or more grooming fixtures. The first fixture is a rake-brush section consisting of a plurality of prongs and the second fixture is a de-shedding unit that is solid stainless steel tapered with a plurality of teeth spaced 0.025 inches apart. The de-shedding unit is set into a boss on the rotating unit. The term, rake-brush has been coined by the inventor because you pull it like a rake and it accomplishes the same desired effects as a brush. An ergonomic tool handle has an orifice in the distal end for hanging in a storage location. A plurality or ribs extend the length of the handle giving a comfortable non-slip surface. The handle connects to the tool head section by the means of the tool neck. The tool head section is composed of a first side member and a second side member with a supporting central web between them. A strengthening rib crosses between the first side member and the second side member on both sides of the supporting central web.

The rake-brush section of the rotating unit has a plurality of prongs in a single line although it must be understood that one or more lines of prongs are anticipated and would be covered within the scope of this patent. A thumb tab is located between the rake brush section and the de-shedding unit to press moving the rotating unit back and forth for the desired grooming operation. The rotating unit incorporates a unique locking mechanism that restrains the unit in either the rake brush position or the de-shedding position.

With respect to the above description then, it is to be realized that the optimum dimensional relationships for the parts of the combination animal grooming tool, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the device. Further, since numerous modifications and changes will readily occur to those skilled in the art, it is not desired to limit the combination animal grooming tool to the exact construction and operation shown and described, and accordingly, all suitable modifications and equivalents may be resorted to, falling within the scope of the device.

### BRIEF DESCRIPTION OF THE DRAWINGS

The accompanying drawings, which are incorporated in and form a part of this specification, illustrate embodiments of the combination animal grooming tool and together with the description, serve to explain the principles of this device.

FIG. 1 depicts a perspective view of the combination animal grooming tool with the rake-brush exposed, constructed in accordance with the present invention;

FIG. 2 depicts a side view of the rotating head with the side removed to expose the rotating shaft and the locking tab, constructed in accordance with the present invention;

FIG. 3 depicts a detail of the inside of one of the sides, exposing the central orifice and the locking depressions, constructed in accordance with the present invention;

FIG. 4 depicts a detail of one end of the rotating unit with the pivot shaft and the locking tab, constructed in accordance with the present invention; and

FIG. 5 depicts a perspective view of the opposite side of the combination animal grooming tool with a de-shedding element exposed, constructed in accordance with the present invention.

### DETAILED DESCRIPTION OF THE PREFERRED EMBODIMENTS

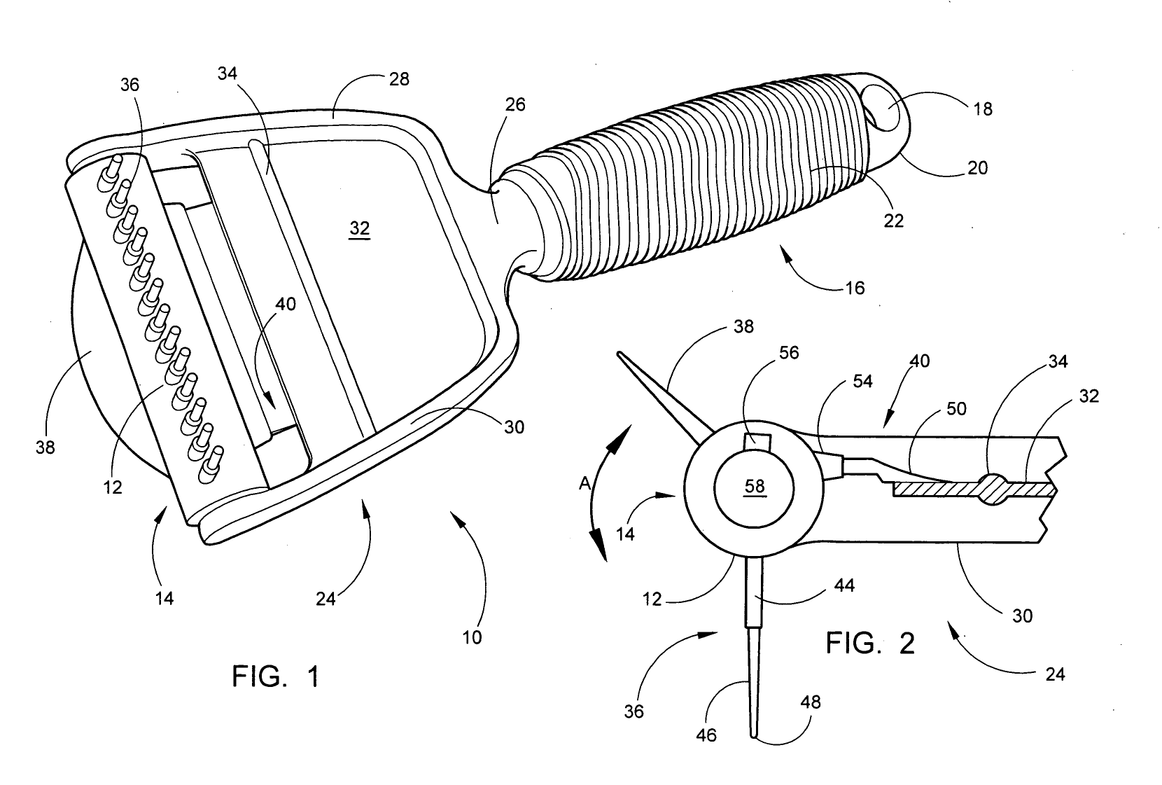

Referring now to the drawings, wherein similar parts of the present combination animal grooming tool 10 are identified by like reference numerals, there is seen in FIG. 1 a perspective view of the combination animal grooming tool 10 with the rake-brush section 12 on the rotating unit 14 exposed. The term, rake-brush has been coined by the inventor because you pull it like a rake and it accomplishes the same desired effects as a brush. The ergonomic tool handle 16 has a handle orifice 18 in the distal end 20 for hanging in a storage location. A plurality of ribs 22 extend the length of the handle 16 giving a comfortable non-slip surface.

The handle 16 connects to the tool head section 24 by the means of the tool neck 26. The tool head section 24 is composed of a first side member 28 and a second side member 30 with a supporting central web 32 between them. A strengthening rib 34 crosses between the first side member 28 and the second side member 30 on both sides of the supporting central web 32. The rotating unit 14 is composed of the rake-brush section 12 with a plurality of prongs 36, a thumb tab 38 and a unique de-shedding unit 40. The de-shedding unit 40 is a solid stainless steel tapered component 50 with a plurality of teeth 52 spaced 0.025 inches apart set into boss 54 on the rotating unit 14 (as best seen in FIG. 5).

FIG. 2 depicts a side view of the rotating head with the side removed to expose the rotating unit 14 and the locking tab 56 and the short pivot shaft 58. Each prong 36 on the rake brush section 12 is composed of a shoulder section 44 and a tapered section 46 with a smooth ball end 48. The rotational arrow A depicts the back and forth movement of the rotating unit 14 when translating between using the rake brush section 12 and the de-shedding unit 42. Thumb tab 36 is positioned approximately half way between the de-shedding unit 40 and the rake brush section 12 with prongs 36. The thumb tab 36 is used to rotate the rotating unit 14 to select either the de-shedding unit 40 and the rake brush section 12 which are positioned approximately 90 degrees from each other. Either tool when selected is locked in position for use. When in either locked position, the rake brush section 12 or the de-shedding unit 40 that is not in use will rest firmly and safely locked in place against the supporting central web 32.

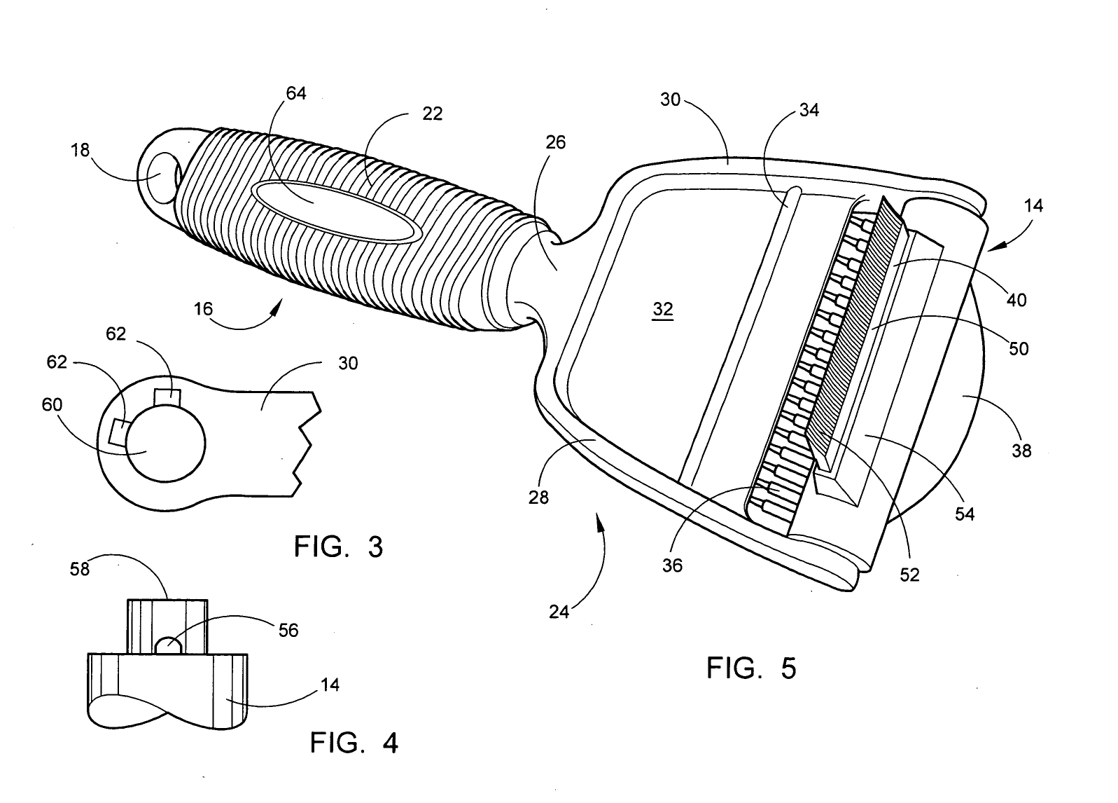

FIG. 3 depicts a detail of the inside of one of the typical sides 30 exposing the central orifice 60 that the pivot shaft 58 rotates within and the locking depressions 62 in which the locking tabs 56 engage within when either the rake brush section 12 or the de-shedding unit 42 are in either locked position. FIG. 4 depicts a detail of one end of the rotating unit 14 with the pivot shaft 58 and locking tab 56.

FIG. 5 depicts a perspective view of the opposite side of the combination animal grooming tool 10 with de-shedding element 40 exposed. The ergonomic tool handle 16 having a plurality of ribs 22 that extend the length of the handle 16 with the nameplate 64 exposed. The handle 16 connects to the tool head section 24 by the means of the tool neck 26. The tool head section 24 is composed of a first side member 28 and a second side member 30 with a supporting central web 32 between them. The de-shedding unit 40 is a solid stainless steel tapered component 50 with a plurality of teeth 52 spaced 0.025 inches apart set into boss 54 on the rotating unit 14. This fine set of teeth 52 spaced so close together, make an effective de-shedding tool as pet hair is removed when using the de-shedding unit 40.

The animal grooming tool 10 shown in the drawings and described in detail herein disclose arrangements of elements of particular construction and configuration for illustrating preferred embodiments of structure and method of operation of the present device. It is to be understood, however, that elements of different construction and configuration and other arrangements thereof, other than those illustrated and described, may be employed for providing a animal grooming tool 10 in accordance with the spirit of this invention, and such changes, alternations and modifications as would occur to those skilled in the art are considered to be within the scope of the combination animal grooming tool as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the combination animal grooming tool in any way.

I claim:

1. A combination pet grooming and de-shedding tool comprising:
(a) a handle having a gripping portion;
(b) a frame portion tool head section having a web portion and a supporting rib;
(c) a combination grooming rake brush unit and de-shedding unit attached to a rotating unit pivotally mounted on said tool head section; and
(d) a thumb tab and a locking tab;
whereby a user selects either said grooming rake brush unit or said de-shedding unit for use by rotationally exposing either said grooming rake brush unit or said de-shedding unit using said thumb tab to actuate rotation of said rotating unit and then locking either said grooming rake brush unit or said de-shedding unit into place for use using said locking tab.

2. The combination pet grooming and de-shedding tool according to claim 1, wherein said handle having a gripping portion further includes a plurality of ribs extending the length of said handle creating a comfortable non-slip gripping surface for the user's hand.

3. The combination pet grooming and de-shedding tool according to claim 1, wherein said handle having a gripping portion further includes a handle orifice for hanging in a storage location and a nameplate for displaying a trademark.

4. The combination pet grooming and de-shedding tool according to claim 1, wherein said a frame portion tool head section having a web portion and a supporting rib further includes a tool head first side member having a terminal end and a tool head second side member having a terminal end, and further whereby said terminal ends pivotally attach to said combination grooming rake brush unit and de-shedding unit.

5. The combination pet grooming and de-shedding tool according to claim 4, wherein said rotating unit further includes a pivot shaft having a locking tab which mates with a locking depression located in said terminal ends of said first side member and said second side member to lock either said rake brush unit or said de-shedding unit into place for use.

6. The combination pet grooming and de-shedding tool according to claim 1, wherein said combination grooming rake brush unit and de-shedding unit pivotally mounted on said tool head section further includes a grooming rake brush unit having a plurality of prongs each of said prongs further comprising a shoulder section and a tapered section.

7. The combination pet grooming and de-shedding tool according to claim 1, wherein said combination grooming rake brush unit and de-shedding unit pivotally mounted on said tool head section further includes a de-shedding unit with teeth spaced about 0.025 inches apart set into boss.

8. The combination pet grooming and de-shedding tool according to claim 1, wherein said grooming rake brush unit and de-shedding unit pivotally mounted on said tool head section further includes said grooming rake brush unit and de-shedding unit mounted at about 90 degrees apart on a rotating unit.

9. The combination pet grooming and de-shedding tool according to claim 1, wherein said thumb tab is positioned about half way between said grooming rake brush unit and de-shedding unit, whereby said thumb tab is used for manual actuation of rotation of the rotating unit.

10. A method for making a combination pet grooming and de-shedding tool comprising the steps of:
(a) providing a handle having a gripping portion;
(b) providing a frame portion tool head section having a web portion and a supporting rib;
(c) providing a grooming rake brush unit and de-shedding unit
(d) attaching said grooming rake brush unit and said de-shedding unit to a rotating unit;
(e) pivotally mounting said rotating unit on said tool head section; and
(d) providing a thumb tab and a locking tab;
whereby a user selects either said grooming rake brush unit or said de-shedding unit for use by rotationally exposing either said grooming rake brush unit or said de-shedding unit using said thumb tab to actuate rotation of said rotating unit and then locking either said grooming rake brush unit or said de-shedding unit into place for use using said locking tab.

11. The method for making a combination pet grooming and de-shedding tool according to claim 10, wherein said step of providing a handle having a gripping portion further includes the step of providing a handle having a plurality of ribs extending the length of said handle creating a comfortable non-slip gripping surface for the user's hand.

12. The method for making a combination pet grooming and de-shedding tool according to claim 10, wherein said step of providing a handle having a gripping portion further includes the step of providing a handle having a handle orifice for hanging in a storage location and a nameplate for displaying a trademark.

13. The method for making a combination pet grooming and de-shedding tool according to claim 10, wherein said step of providing a frame portion tool head section having a web portion and a supporting rib further includes the step of providing a frame portion tool head section having a tool head first side member having a terminal end and a tool head second side member having a terminal end, and further whereby said terminal ends pivotally attach to said combination grooming rake brush unit and de-shedding unit.

14. The method for making a combination pet grooming and de-shedding tool according to claim 13, further comprising the steps of
(a) providing a rotating unit further including a pivot shaft having a locking tab; and
(b) mating said locking tab with a locking depression located in said terminal ends of said first side member and said second side member
thereby locking either said rake brush unit or said de-shedding unit into place for use.

15. The combination pet grooming and de-shedding tool according to claim 10, wherein said step of providing a grooming rake brush unit and de-shedding unit pivotally mounted on said tool head section further includes the step of providing a grooming rake brush unit having a plurality of prongs each of said prongs further comprising a shoulder section and a tapered section.

16. The method for making a combination pet grooming and de-shedding tool according to claim 10, wherein said step of providing a grooming rake brush unit and de-shedding unit pivotally mounted on said tool head section further includes the step of providing a de-shedding unit with teeth spaced about 0.025 inches apart set into boss.

17. The method for making a combination pet grooming and de-shedding tool according to claim 10, wherein said step of attaching said grooming rake brush unit and said de-shedding unit to a rotating unit further includes the step of mounting said grooming rake brush unit and de-shedding unit at about 90 degrees apart on said rotating unit.

18. The method for making a combination pet grooming and de-shedding tool according to claim 10, wherein said step of providing a thumb tab further includes the step of providing a thumb tab positioned about half way between said grooming rake brush unit and de-shedding unit, whereby said thumb tab is used for manual actuation of rotation of the rotating unit.

19. The method for making a combination pet grooming and de-shedding tool according to claim 10, wherein said step of pivotally mounting said rotating unit on said tool head section further includes providing a pivot shaft having a locking tab integral to said rotating unit, and further providing locking depressions in said tool head section for mating with said locking tabs thereby locking the selected tool, either the brush rake unit or the de-shedding unit into place for use, and locking the unit not in use securely and safely against said web portion of said tool head section.

20. A method for using the combination pet grooming and de-shedding tool, constructed according to claim 10, comprising the steps of:
(a) grasping said handle of the combination pet grooming and de-shedding tool in one hand and grasping said thumb tab in the other hand;
(b) rotating said rotating unit using said thumb tab and selecting either the brush rake unit or the de-shedding unit by rotating that unit into a position for use and locking the unit in that position, then releasing the thumb tab from the other hand;
(c) using the selected tool to either brush rake or de-shed the pet by running the selected tool through the pet hair;
(d) selecting the other unit by again grasping the thumb tab with the other hand and rotating the selected unit into a position for use and locking the unit into that position, then releasing the thumb tab from the other hand;
(e) running the selected unit through the pet hair to either brush rake or de-shed the pet;
whereby either the brush rake unit or the de-shedding unit are readily selected, rotated into place and locked into place for use or safe storage.
